(19) United States
(12) Patent Application Publication
(10) Pub. No.: US 2015/0221952 A1
(43) Pub. Date: Aug. 6, 2015

(54) POSITIVE ELECTRODE FOR LITHIUM AIR BATTERY AND LITHIUM AIR BATTERY INCLUDING THE SAME

(71) Applicant: Samsung Electronics Co., Ltd., Suwon-si (KR)

(72) Inventors: Sang-bok MA, Suwon-si (KR); Dong-min IM, Seoul (KR); Dong-joon LEE, Yongin-si (KR); Ki-hyun KIM, Seoul (KR); Tae-young KIM, Seoul (KR)

(21) Appl. No.: 14/467,409

(22) Filed: Aug. 25, 2014

(30) Foreign Application Priority Data
Feb. 6, 2014 (KR) 10-2014-0013826

(51) Int. Cl. H01M 4/62; H01M 4/133; H01M 12/02; H01M 12/00

(52) U.S. Cl. CPC H01M 4/62; H01M 12/00; H01M 4/133; H01M 12/02; H01M 2300/0082

(57) ABSTRACT

A lithium air battery including a negative electrode capable of incorporation and deincorporation of lithium ions, a positive electrode capable of capable of incorporating and deincorporating oxygen, and a lithium ion conductive polymer electrolyte disposed between the negative electrode and the positive electrode, wherein the positive electrode includes a carbonaceous material and a carbide of a metal or a semi-metal element. The lithium ion conductive polymer electrolyte may include a lithium salt and a hydrophilic polymer.

### RELATED APPLICATION

This application claims the benefit of Korean Patent Application No. 10-2014-0013826, filed on Feb. 6, 2014, in the Korean Intellectual Property Office, and all the benefits accruing therefrom under 35 U.S.C. §119, the content of which is incorporated herein in its entirety by reference.

### BACKGROUND

1. Field

The present disclosure relates to a positive electrode for a lithium air battery and a lithium air battery including the same, and more particularly, to a positive electrode for a lithium air battery and a lithium air battery including the positive electrode, the lithium battery having a high discharge capacity, charging/discharging efficiency, and discharge voltage.

2. Description of the Related Art

Lithium air batteries include a negative electrode in which lithium ions are intercalatable and deintercalatable, a positive electrode using oxygen from the air as a positive electrode active material, and a lithium ion conductive medium between the positive electrode and the negative electrode.

Lithium air batteries have a theoretical energy density of 3500 Wh/kg or greater, which is about 10 times greater than that of lithium ion batteries. In addition, lithium air batteries are environmentally safe and have better stability than lithium ion batteries. However actual batteries do not provide such performance.

Therefore, there remains a need for a positive electrode for a lithium air battery and a lithium air battery including the same, having an improved discharge capacity, charging/discharging efficiency, and discharge voltage.

### SUMMARY

Provided is a positive electrode for a lithium air battery having an improved discharge capacity, charging/discharging efficiency, and charge voltage.

Provided is a lithium air battery including the positive electrode.

Additional aspects will be set forth in part in the description which follows and, in part, will be apparent from the description.

According to an aspect, a lithium air battery includes a negative electrode capable of incorporation and deincorporation lithium ions; a positive electrode capable of incorporating and deincorporating oxygen; and a lithium ion conductive polymer electrolyte between the positive electrode and the negative electrode, wherein the positive electrode includes a carbonaceous material and a carbide of a metal or a semi metal element.

According to an aspect, disclosed is a lithium air battery including: a negative electrode capable of incorporation and deincorporation of lithium ions; a positive electrode capable of incorporating and deincorporating oxygen, wherein the positive electrode includes a carbonaceous material and a carbide of a metal or a semi-metal element, and a lithium ion conductive polymer electrolyte; and a lithium ion conductive polymer electrolyte membrane between the negative electrode and the positive electrode.

According to another aspect, a positive electrode for a lithium battery includes a carbonaceous material and a carbide of a metal or a semi metal element.

Also disclosed is a method of manufacturing a lithium air battery, the method including: providing a negative electrode capable of incorporation and deincorporation of lithium ions; providing a positive electrode capable of incorporating and deincorporating oxygen, wherein the positive electrode includes a carbonaceous material and a carbide of a metal or a semi-metal element; disposing a lithium ion conductive polymer electrolyte between the negative electrode and the positive electrode; and impregnating the lithium ion conductive polymer electrolyte in the positive electrode to manufacture the lithium air battery.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of an embodiment of a portion of a positive electrode illustrating that formation of a three-phase boundary is induced from the polymer electrolyte impregnated in a portion the positive electrode;

FIG. 2 is a schematic view illustrating a structure of an embodiment of a lithium air battery; and

FIG. 3 is graph of potential (volts, V) versus capacity (milliampere-hours per gram) of a first charging/discharging cycle of lithium air batteries prepared in Examples 1 to 3 and Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. “Or” means “and/or.” Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Alkylene” means a straight or branched chain, saturated, divalent aliphatic hydrocarbon group, (e.g., methylene (—CH₂—) or, propylene (—(CH₂)₃—)).

“Alkylene oxide” means an alkyl group that is linked via an oxygen (i.e., alkyl-O—), for example methoxy, ethoxy, and sec-butyloxy groups.

Hereinafter, according to an embodiment, a positive electrode for a lithium air battery and a lithium air battery including the same will be disclosed in further detail.

In a lithium air battery, the lithium ion conductive medium between the negative electrode and the positive electrode may be an aqueous electrolyte or a non-aqueous electrolyte, and the non-aqueous electrolyte may be, for example, an organic electrolyte solution or a polymer electrolyte solution including a lithium salt. However, when an aqueous electrolyte is used as an electrolyte, the lithium air battery may be severely corroded due to contact between lithium and the aqueous electrolyte. Thus there is increased interest a non-aqueous electrolyte for a lithium air battery. However, when a polymer electrolyte is used as the non-aqueous electrolyte, wetting of the positive electrode in a lithium air battery by the polymer electrolyte may be deteriorated as a hydrophobic carbonaceous material included in the positive electrode is not wetted by the polymer electrolyte. As a result, a discharge capacity and a discharge voltage of the positive electrode and the lithium air battery may be deteriorated.

According to an aspect, provided is a lithium air battery including a negative electrode capable of incorporating or deincorporating, e.g., intercalating and deintercalating, lithium ions, a positive electrode capable of incorporating and deincorporating oxygen as a positive electrode active material, and a lithium ion conductive polymer electrolyte disposed between the negative electrode and the positive electrode, wherein the positive electrode includes a carbonaceous material and a carbide of a metal or a semi metal element.

When a non-aqueous electrolyte is used as an electrolyte, the lithium air battery including the non-aqueous electrolyte may have reaction mechanisms represented by Reaction scheme 1 as follows:

4Li+O₂ [symbol] 2Li₂O E^{o}=2.91V

2Li+O₂ [symbol] Li₂O₂ E^{o}=3.10V Reaction scheme 1

When the lithium air battery is discharged, lithium derived from the negative electrode contacts oxygen introduced from the positive electrode, and thus a lithium oxide is produced and oxygen is reduced in an oxygen reduction reaction, also referred to as “ORR”. On the other hand, when the lithium air battery is charged, a lithium oxide is reduced and oxygen is evolved by oxidation in an oxygen evolution reaction, also referred to as “OER”.

According to Reaction scheme 1, Li₂O₂ is precipitated from a carbonaceous material included in the positive electrode, in particular, in pores of a porous carbonaceous material. While not wanting to be bound by theory, it is understood that a capacity of the lithium air battery is determined by an amount of the precipitated Li₂O₂ filling the pores of the positive electrode. The amount of the precipitated Li₂O₂ filling the pores of the positive electrode increases as an amount of oxygen diffused to the positive electrode and a concentration of lithium is increased. Thus, an amount of lithium supplied to the reaction interface through the electrolyte in the positive electrode and an amount of oxygen supplied through the pores of the positive electrode are factors that can determine performance of the positive electrode.

However, when a non-aqueous electrolyte, such as a polymer electrolyte, for example a hydrophilic polymer electrolyte, is used as the electrolyte, a three-phase boundary in which the electrolyte, a surface of the carbonaceous material, and the air contact is not easily formed due to hydrophobic properties of the surface of the carbonaceous material. As a result, and while not wanting to be bound by theory, it is understood that lithium supply from the electrolyte may be interrupted, and thus a discharge capacity may decrease. Also, a cell resistance of the lithium air battery including the electrolyte may increase, and a discharge voltage may decrease.

The lithium air battery according to an embodiment includes a carbide of a metal or a semi-metal element as an additive in the positive electrode. The carbide of a metal or a semi-metal element has hydrophilic properties. Therefore, and while not wanting to be bound by theory, it is understood that when the positive electrode includes the carbide of a metal or a semi-metal element, the hydrophilic polymer electrolyte readily contacts the carbide of a metal or a semi-metal element, and thus electrolyte wettability and electrolyte accessibility to the positive electrode may increase. In this regard, formation of a three-phase boundary in contact with the electrolyte, a surface of the carbonaceous material, and the air may be facilitated. Also, the carbide of a metal or a semi-metal element includes a metal or a semi-metal element, and thus the carbide of the metal or the semi-metal element has high electrical conductivity, corrosion resistant properties in a wide range of voltage (e.g., about 0 V to about 4.5 V, or about 0.2 V to about 4.3 V, or about 0.4 V to about 4.1 V vs. lithium metal), and improved thermal stability at a high temperature.

Thus, the positive electrode including the carbide of a metal or a semi-metal element as an additive, and a lithium air battery including the positive electrode, may have improved discharge capacity, improved charging/discharging efficiency, and an improved discharge voltage.

The lithium ion conductive polymer electrolyte may include a lithium salt and a hydrophilic polymer.

The hydrophilic polymer may include at least one selected from an alkylene oxide-based polymer, a hydrophilic acryl-based polymer, a hydrophilic methacryl-based polymer, a hydrophilic acrylonitrile-based polymer, a hydrophilic vinylidene fluoride-based polymer, a hydrophilic urethane-based polymer, and a hydrophilic cellulose-based polymer. For example, the hydrophilic polymer may include at least one selected from an alkylene oxide-based polymer, for example a polymer comprising ethylene oxide units, propylene oxide units, or a combination thereof, a hydrophilic acryl-based polymer, for example a polymer comprising methyl acrylate units, acrylic acid units, or a combination thereof, and a hydrophilic methacryl-based polymer, for example a polymer comprising methyl methacrylate units, methacrylic acid units, or a combination thereof.

The alkylene oxide-based polymer has an alkylene oxide chain, which is a branched chain in which an alkylene group and an ether oxygen are alternately arranged, and the alkylene oxide chain may have a branch.

Examples of the alkylene oxide-based polymer may include at least one selected from a polyethylene oxide, a polypropylene oxide, and a polyethyleneoxide/polypropyleneoxide copolymer.

The hydrophilic acryl-based polymer and the hydrophilic methacryl-based polymer, respectively, refer to an acryl-based polymer and a methacryl-based polymer each having a hydrophilic group. The hydrophilic group may be any suitable functional group that provides hydrophilic properties, and examples of the hydrophilic group may include at least one selected from a phosphate group, a sulfonic acid group, a carbonyl group (—C(═O)—), a hydroxyl group (—OH), an ether group (—O—), and a carboxylic acid ((—C(═O)—OH). When the hydrophilic polymer is included in the electrolyte, reduction may be facilitated in the positive electrode.

The lithium salt may include at least one selected from LiPF₆, LiBF₄, LiSbF₆, LiAsF₆, LiN(SO₂CF₃)₂, LiN(SO₂C₂F₅)₂, LiN(SO₂F₂)₂, LiC₄F₉SO₃, LiClO₄, LiAlO₂, LiAlCl₄, LiN(CₓF₂ₓ₊₁SO₂)(C_{y}F_{2y+1}SO₂) (wherein x and y are each a natural number), LiF, LiBr, LiCl, LiI, and LiB(C₂O₄)₂ (lithium bis(oxalato) borate).

An amount of the lithium salt may be in a range of about 0.01 molar (M) to about 10 M, for example, about 0.1 M to about 2.0 M. When an amount of the lithium salt is within this range, a lithium ion conductive polymer electrolyte may have excellent electrolyte performance as lithium ions may effectively transport in the electrolyte and the electrolyte has an appropriate viscosity and conductivity.

Also, the electrolyte may include another salt, such as a metal salt, in addition to the lithium salt. Examples of the metal salt include at least one selected from AlCl₃, MgCl₂, NaCl, KCl, NaBr, KBr, and CaCl₂.

The positive electrode includes a carbonaceous material and a carbide of a metal or a semi-metal element, and optionally a lithium ion conductive polymer electrolyte may be disposed in, e.g., impregnated in, the positive electrode. The lithium ion conductive polymer electrolyte may be at least partially disposed in a portion of the positive electrode, e.g., in about 10 volume percent (vol %) to about 90 vol %, or about 20 vol % to about 80 vol % of the positive electrode, or the lithium ion conductive polymer electrolyte may be disposed in an entirety of the positive electrode. A three-phase boundary in which the electrolyte, the surface of the carbonaceous material, and the air contact may form when the lithium ion conductive polymer electrolyte is disposed in, e.g., impregnated in, or contacts a surface of the positive electrode. A content of the lithium ion conductive polymer electrolyte in the positive electrode may be 0 weight percent (wt %) to about 90 wt %, or about 10 wt % to about 80 wt %, or about 20 wt % to about 70 wt %, based on a total weight of the positive electrode including the positive electrode active material and the lithium ion conductive polymer electrolyte included in the positive electrode, if any.

The positive electrode may include a composite of a carbonaceous material and a carbide of a metal or a semi-metal element.

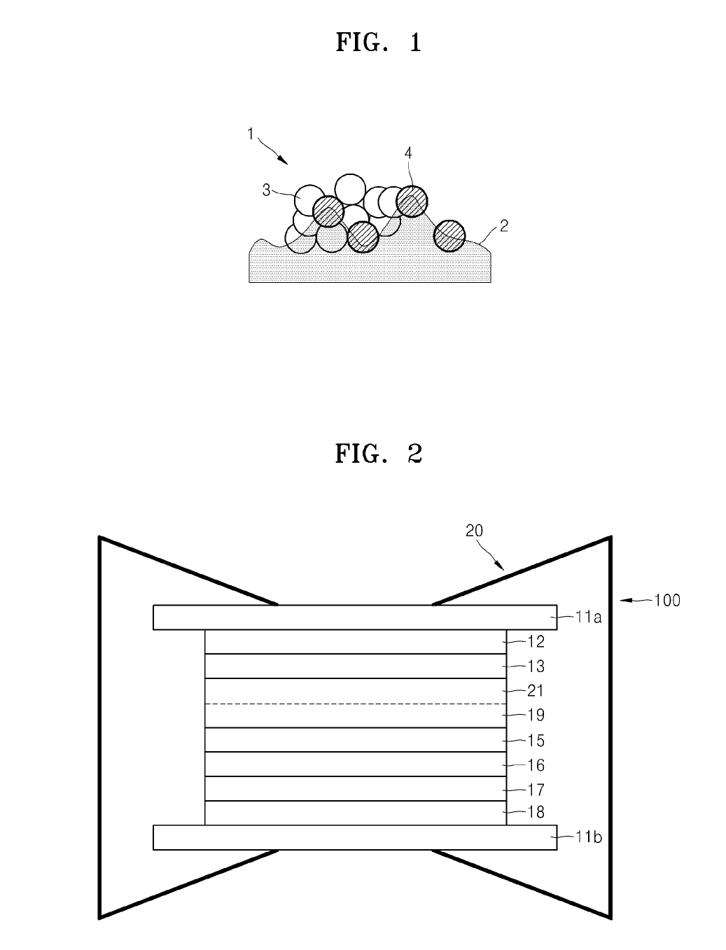

FIG. 1 is a schematic view of an embodiment of a polymer electrolyte impregnated in a portion of a positive electrode illustrating that formation of a three-phase boundary is induced from a polymer electrolyte 2 impregnated in a portion of a positive electrode 1. Referring to FIG. 1, the positive electrode 1 includes a composite of a carbonaceous material 3 and a carbide of a metal 4 or a semi-metal element, and the polymer electrolyte 2 is disposed in, e.g., impregnated in, a portion of the positive electrode 1. In particular, FIG. 1 illustrates that formation of a three-phase boundary is induced from the combination of the polymer electrolyte 2 contacting the carbide 4 of a metal or a semi-metal element.

Accessibility of the positive electrode 1 to a polymer electrolyte increases, and thus a discharge capacity, a charging/discharging efficiency, and a discharge voltage of the positive electrode may be improved when the positive electrode includes the polymer electrolyte.

Since a redox reaction of oxygen occurs on a surface of the carbide of a metal or a semi-metal element, the positive electrode with the carbide of a metal or a semi-metal element coated on a surface of a carbonaceous material has a formation principle different from that of the disclosed positive electrode. In particular, when a liquid electrolyte is used in the positive electrode, wettability and accessibility of the electrolyte are better than when a polymer electrolyte is used, and thus an effect produced by combining the carbide of a metal or a semi-metal element in the positive electrode may be improved when a polymer electrolyte is used.

The carbide of a metal or a semi-metal element may be a carbide of at least one element selected from Si, Ti, Mn, Co, Ni, V, Ge, Nb, Zr, Mo, Fe, Al, Ag, Cr, Sn, Ta, and W. For example, the carbide of a metal or a semi-metal element may be a carbide of at least one element selected from Si, Ti, Zr, and Cr. The carbide of a metal or a semi-metal element may have excellent anti-corrosion and anti-oxidation properties, and excellent thermal stability and mechanical strength at high temperature as well.

An average particle diameter of the carbide of a metal or a semi-metal element may be in a range of about 1 nanometer (nm) to about 10 micrometers (μm), or about 10 nm to about 1 μm, or about 50 nm to about 0.5 μm. When an average particle diameter of the carbide of a metal or a semi-metal element is within this range, a composite of the carbide and a carbonaceous material may be suitably formed, and thus an area of the three-phase boundary in contact with an electrolyte, a carbonaceous material surface, and air may be enlarged.

An amount of the carbide of a metal or a semi-metal element may be in a range of about 1 part to about 30 parts by weight, or about 2 parts to about 20 parts by weight, or about 4 parts to about 10 parts by weight, based on 100 parts by weight of the total positive electrode, in which the lithium ion conductive polymer electrolyte is disposed in a portion of or in an entirety of the positive electrode. For example, an amount of the carbide of a metal or a semi-metal element may be in a range of about 1 part to about 25 parts by weight, based on 100 parts by weight of the total positive electrode, in which the lithium ion conductive polymer electrolyte is disposed in a portion of or in an entirety of the positive electrode. For example, an amount of the carbide of a metal or a semi-metal element may be in a range of about 1 part to about 20 parts by weight, based on 100 parts by weight of the total positive electrode, in which the lithium ion conductive polymer electrolyte is disposed in a portion of or in an entirety of the positive electrode. When an amount of the carbide of a metal or a semi-metal element is within this range, the positive electrode may have an enlarged three-phase boundary area in which the electrolyte, the carbonaceous material surface, and air contact. Thus, a discharge capacity, a charging/discharging efficiency, and a discharge voltage of the positive electrode may be improved.

The carbonaceous material may include a porous carbonaceous material. Examples of the porous carbonaceous material include, for example, carbon black, graphite, graphene, active carbon, and carbon fiber. In particular, the porous carbonaceous material may be a carbonaceous material comprising carbon particles or spheres, and may comprise at least one selected from a mesoporous carbon, carbon tube, carbon fiber, carbon sheet, and carbon rod, but is not limited thereto.

An average particle diameter of a primary particle of the porous carbonaceous material may be in a range of about 10 nm to about 1 μm, or about 25 nm to about 0.8 μm, or about 50 nm to about 0.6 μm. For example, an average particle diameter of a primary particle of the porous carbonaceous material may be in a range of about 20 nm to about 1 μm. An average particle diameter of a secondary particle of the porous carbonaceous material may be in a range of about 100 nm to about 10 μm. For example, an average particle diameter of a secondary particle of the porous carbonaceous material may be in a range of about 200 nm to about 10 μm.

When average particle diameters of the primary particles and the secondary particles of the porous carbonaceous material are within these ranges, a specific surface area of the porous carbonaceous material may be about 10 square meters per gram (m²/g) or greater, or about 10 m²/g to about 1000 m²/g, or about 100 m²/g to about 500 m²/g, and thus an area of the porous carbonaceous material in contact with oxygen in the air may increase, and as a result, a discharge capacity and a charging/discharging efficiency of the positive electrode may be improved.

An average discharge voltage of the positive electrode may be greater than 2.30 volts (V). For example, an average discharge voltage of the positive electrode may be greater than 2.31 V.

A discharge capacity per unit weight of the positive electrode may be greater than 400 mAh/g, for example 400 mAh/g to 1000 mAh/g. For example, a discharge capacity per unit weight of the positive electrode may be greater than 410 mAh/g. For example, a discharge capacity per unit weight of the positive electrode may be greater than 420 mAh/g.

The positive electrode may further include an oxygen oxidation/reduction catalyst. Examples of the oxygen oxidation/reduction catalyst may include, for example, a precious metal catalyst such as platinum, gold, silver, palladium, ruthenium, rhodium, and osmium; an oxide catalyst such as manganese oxide, iron oxide, cobalt oxide, and nickel oxide, or a organometallic catalyst such as cobalt phthalocyanine, but is not limited thereto, and any suitable oxygen oxidation/reduction catalyst may be used.

The oxygen oxidation/reduction catalyst may be impregnated in a supporting material. The supporting material may be, for example, an oxide, a zeolite, a clay mineral, or carbon. The oxide may include at least one oxide of alumina, silica, zirconium oxide, and titanium dioxide. The oxide may include at least one metal selected from Ce, Pr, Sm, Eu, Tb, Tm, Yb, Sb, Bi, V, Cr, Mn, Fe, Co, Ni, Cu, Nb, Mo, and W. The carbon may include, for example, a carbon black such as Ketjen black, acetylene black, channel black, or lamp black; a graphite such as natural graphite, artificial graphite, or expanded graphite; an active carbon; or a carbon fiber, but is not limited thereto, and any suitable supporting material may be used.

The positive electrode may further include a binder. The binder may include a thermoplastic resin and/or a thermosetting resin, and for example, may include at least one selected from polyethylene, polypropylene, polytetrafluoroethylene (“PTFE”), polyvinylidene fluoride (“PVDF”), styrene-butadiene rubber, tetrafluoroethylene-perfluoroalkylvinylether copolymer, vinylidene fluoride-hexafluoropropylene copolymer, vinylidene fluoride-chlorotrifluoroethylene copolymer, ethylene-tetrafluoroethylene copolymer, polychlorotrifluoroethylene, vinylidene fluoride-pentafluoropropylene copolymer, propylene-tetrafluoroethylene copolymer, ethylene-chlorotrifluoroethylene copolymer, vinylidene fluoride-hexafluoropropylene-tetrafluoroethylene copolymer, vinylidene fluoride-perfluororomethylvinylether-tetrafluoro ethylene copolymer, and ethylene-acrylic acid copolymer alone or in combination, but is not limited thereto, and any suitable binder may be used.

The positive electrode may be manufactured, for example, by preparing a positive electrode slurry by mixing the carbonaceous material, the carbide of the metal or the semi-metal element, an oxygen oxidation/reduction catalyst, and optionally a binder, and then adding a suitable solvent; and coating the slurry on the surface of a first current collector followed by drying or, alternatively by compression molding on the first current collector for improvement of a positive electrode energy density. Furthermore, the positive electrode may selectively include a lithium oxide. Furthermore, alternatively, the oxygen oxidation/reduction catalyst may be omitted.

The first current collector may be porous and may serve as a gas diffusion layer for the diffusion of air. The first current collector may use a net-like or mesh-like porous material to expedite the diffusion of oxygen, and may comprise for example, a porous metal plate made of stainless steel wire (e.g., SUS), nickel, or aluminum, but is not limited thereto, and any suitable current collector may be used. The first current collector may be coated with an antioxidant metal or alloy film so as to prevent it from being oxidized. A Teflon® case and a pressing member to deliver air to the positive electrode may be disposed on the first current collector.

Alternatively, a gas diffusion layer may be disposed on the first current collector. The gas diffusion layer serves to increase the diffusion of oxygen so that the oxygen in the air can contact with the entire surface of the positive electrode. The gas diffusion layer may be treated for water repellency. A material used for water repellency may be a porous membrane comprising a fluororesin. The fluororesin may include at least one selected from polytetrafluoroethylene (“PTFE”), polyfluorovinylidene (“PVdF”), tetrafluoroethylene-hexafluoroethylene copolymer, tetrafluoroethylene-hexafluoropropylene copolymer (“FEP”), tetrafluoroethylene-perfluoroalkyl vinyl ether copolymer (“PFA”), vinylidene fluoride-hexafluoropropylene copolymer, vinylidene fluoride-chlorotrifluoroethylene copolymer, ethylene-tetrafluoroethylene copolymer (e.g., an ETFE resin), polychlorotrifluoroethylene (“PCTFE”), vinylidene fluoride-pentafluoropropylene copolymer, propylene-tetrafluoroethylene copolymer, ethylene-chlorotrifluoroethylene copolymer (“ECTFE”), and vinylidene fluoride-hexafluoropropylene-tetrafluoroethylene copolymer.

FIG. 2 is a schematic view illustrating a structure of an embodiment of a lithium air battery 100. As shown in FIG. 2, a positive electrode 21 includes the carbonaceous material, the carbide of a metal or a semi-metal element, and the oxygen oxidation/reduction catalyst, and a lithium ion conductive polymer electrolyte 19 is disposed at a location near or adjacent to the positive electrode 21. In an embodiment, a portion or an entirety of the polymer electrolyte 19 may be disposed in, e.g., impregnated in or diffused into, the positive electrode 21. A gas diffusion layer 13, a first current collector 12, and a case 11a are sequentially disposed on the positive electrode 21, in which the lithium ion conductive polymer electrolyte 19 is disposed. The case 11a may comprise Teflon®, for example.

The descriptions of the carbonaceous material, the carbide of a metal or a semi-metal, the oxygen oxidation/reduction catalyst, the lithium ion conductive polymer electrolyte 10, the gas diffusion layer 13, the first current collector 12, and the case 11a are the same as described above and thus are omitted hereinafter.

Also, a lithium ion conductive solid electrolyte membrane 15 may optionally be disposed between a negative electrode 17 and the lithium ion conductive polymer electrolyte 19. The lithium ion conductive solid electrolyte membrane 15 may serve as a protection layer that prevents lithium included in the negative electrode 17 from directly reacting with impurities, such as water and oxygen, in the electrolyte.

The lithium ion conductive solid electrolyte membrane 15 may include at least one selected from a lithium ion conductive glass and a crystalline lithium ion conductive phase. The crystalline lithium ion conductive phase may be polycrystalline, and may comprise a ceramic or a glass-ceramic. The lithium ion conductive solid electrolyte membrane is not limited thereto, and any suitable solid electrolyte membrane that is lithium ion conductive and capable of protecting a negative electrode may be used. However, in consideration of chemical stability, the lithium ion conductive solid electrolyte membrane 15 may be an oxide.

An example of the lithium ion conductive crystal may be Li_{1+x+y}(Al, Ga)ₓ(Ti, Ge)₂₋ₓSi_{y}P_{3-y}O₁₂ (where, 0≦x≦1 and 0≦y≦1, for example, 0≦x≦0.4 and 0<y≦0.6 or 0.1≦x≦0.3 and 0.1<y≦0.4). Examples of the lithium ion conductive glass-ceramic include lithium-aluminum-germanium-phosphate (“LAGP”), lithium-aluminum-titanium-phosphate (“LATP”), and lithium-aluminum-titanium-silicon-phosphate (“LATSP”). Also, alternatively, the lithium ion conductive solid electrolyte membrane 15 may further include an inorganic solid electrolyte. Examples of the inorganic solid electrolyte include Cu₃N, Li₃N, or LiPON. The lithium ion conductive solid electrolyte membrane 15 may be a single layer or multiple layers.

A lithium ion conductive polymer electrolyte membrane 16 may optionally be further disposed between the lithium ion conductive solid electrolyte membrane 15 (if present) and the negative electrode 17. The lithium ion conductive polymer electrolyte membrane 16 may be, for example, a polyethylene oxide doped with a lithium salt, wherein examples of the lithium salt include LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, or LiAlCl₄.

In an embodiment, a lithium air battery comprises the negative electrode capable of incorporation and deincorporation of lithium ions; the positive electrode capable of incorporating and deincorporating oxygen, wherein the positive electrode comprises the carbonaceous material and the carbide of a metal or a semi-metal element, and the lithium ion conductive polymer electrolyte; and the lithium ion conductive polymer electrolyte membrane between the negative electrode and the positive electrode.

Examples of the negative electrode 17 may include a lithium metal, an alloy based on a lithium metal, or a lithium intercalation compound, but are not limited thereto, and any suitable material that includes lithium, or is capable of reversibly incorporating, e.g., intercalating, lithium may be used as a negative electrode. The alloy based on a lithium metal may be, for example, a lithium alloy containing aluminum, tin, magnesium, indium, calcium, titanium, or vanadium. The negative electrode 17 may effectively determine a capacity of a lithium air battery and may be, for example, a lithium metal thin layer.

The negative electrode 17 may also include a binder. The binder may be, for example, polyfluorovinylidene (“PVdF”) or polytetrafluoroethylene (“PTFE”). An amount of the binder is not particularly limited and may be, for example, about 30 parts by weight or less, based on 100 parts by weight of the negative electrode 17, in particular, from about 1 part by weight to about 10 parts by weight, based on 100 parts by weight of the negative electrode 17.

A second current collector 18 may not be particularly limited as long as it has suitable conductivity, and may include for example, stainless steel, nickel, copper, aluminum, iron, titanium, or carbon. The second current collector 18 may be in the form of a thin film, a plate, a mesh, or a grid, for example, a copper foil. The second current collector 18 may be fixed to a Teflon® case 11b.

A separator (not shown) may be disposed between the lithium ion conductive solid electrolyte membrane 15 and the negative electrode 17. The separator may not be particularly limited and any suitable separator for the lithium air battery may be used, for example, a polymer non-woven fabric made of polypropylene or polyphenylene sulfide, or a porous film of olefin resin of polyethylene or polypropylene, or a combination thereof may be used.

The lithium air battery 100 may be, for example, manufactured as follows:

First, the lithium salt and a lithium ion conductive polymer electrolyte precursor of the hydrophilic polymer is mixed with a solvent, such as N-methyl-2-pyrrolidone (“NMP”) to prepare a lithium ion conductive polymer electrolyte precursor, and then the carbonaceous material, the carbide of a metal or a semi-metal element, and the oxygen oxidation/reduction catalyst are mixed with the lithium ion conductive polymer electrolyte precursor and stirred to prepare a positive electrode slurry including a lithium ion conductive polymer electrolyte.

Alternatively, the carbonaceous material, the carbide of a metal or a semi-metal element, and the oxygen oxidation/reduction catalyst; the lithium salt and a lithium ion conductive polymer electrolyte precursor of the hydrophilic polymer; and a solvent, such as NMP are simultaneously mixed and stirred to prepare a positive electrode slurry including a lithium ion conductive polymer electrolyte.

Subsequently, after coating the positive electrode slurry including the lithium ion conductive polymer electrolyte on a lithium ion conductive solid electrolyte membrane, a portion of or an entirety of the electrolyte is impregnated in the positive electrode by drying and heat-treating. Here, the heat-treating may be performed at a temperature in a range of about 60° C. to about 160° C., or about 70° C. to about 150° C., or about 80° C. to about 140° C. in a vacuum for about 1 hour to about 36 hours, about 2 hours to about 25 hours.

Next, the negative electrode is installed on one side of a case, and a lithium ion conductive solid electrolyte membrane, on which the positive electrode in which the lithium ion conductive polymer electrolyte is impregnated, is installed on the opposite side of the negative electrode.

Then, a porous current collector is disposed on the positive electrode, and a pressing member disposed thereon for enabling air to be transferred to the positive electrode is pressed to fix the cell, thereby completing manufacture of a lithium air battery. A separator may be additionally disposed between the lithium ion conductive solid electrolyte membrane and the positive electrode.

The lithium air battery may be used in any of a lithium primary battery and a lithium secondary battery. Also, a shape of the battery is not particularly limited, and the shape of the lithium air battery may be, for example, a coin type, a button type, a sheet type, a stack type, a cylinder type, a flat type, or a cone type. Also, the lithium air battery may be applied to a large-size battery that may be used in an electric vehicle.

As used herein, the term “air” is not limited to air in the atmosphere and may be a combination of a gas including oxygen or may be pure oxygen gas. A broad definition of the term “air” may apply to various fields, for example, an air battery or an air positive electrode.

Hereinafter, the present disclosure will be described in further detail with reference to the following examples. These examples are for illustrative purposes only and shall not limit the scope of the present disclosure.

Also, in the description, certain detailed explanations are omitted when it is deemed that they may unnecessary.

### EXAMPLES

### Preparation of Positive Electrode, in which Lithium Ion Conductive Polymer Electrolyte is Impregnated

### Preparation Example 1

### Preparation of Positive Electrode, in which Lithium Ion Conductive Polymer Electrolyte is Impregnated

4.14 g of polyethylene oxide (PEO, a weight average molecular weight: 600,000 Daltons, Aldrich), and 1.5 g of LiN(SO₂CF₃)₂ (lithium bis(trifluoromethanesulfonyl)imide, “LiTFSI”) were mixed with a solvent, N-methylpyrrolidone (“NMP”), to prepare a lithium ion conductive polymer electrolyte precursor. 1.0 g of the lithium ion conductive polymer electrolyte precursor was mixed with 1.0 g of Pt/C (Pt: 28 wt %, Tanaka) and 0.1 g of TiC and stirred for 15 minutes in a mortar to prepare a positive electrode slurry including a lithium ion conductive polymer electrolyte.

The positive electrode slurry was coated on a lithium-aluminum titanium phosphate (“LATP”) lithium ion conductive solid electrolyte membrane with a thickness of 250 μm (glass-ceramic, OHARA), dried at a temperature of 25° C. for 24 hours, and then heat-treated in vacuum at 120° C. for 2 hours to prepare a positive electrode, in which a lithium ion conductive polymer electrolyte is impregnated.

Here, an amount of TiC used in the positive electrode slurry was about 5 parts by weight, based on 100 parts by weight of the entire positive electrode, in which a lithium ion conductive polymer electrolyte is impregnated, and a weight ratio of Pt/C:polyethylene oxide+LiN(SO₂CF₃) was 1:1.

### Preparation Example 2

### Preparation of Positive Electrode, in which Lithium Ion Conductive Polymer Electrolyte is Impregnated

4.14 g of polyethylene oxide (PEO, a weight average molecular weight: 600,000 Daltons, Aldrich), and 1.5 g of LiN(SO₂CF₃)₂ (lithium bis(trifluoromethanesulfonyl)imide, “LiTFSI”) were mixed with a solvent, NMP, to prepare a lithium ion conductive polymer electrolyte precursor. 1.0 g of the lithium ion conductive polymer electrolyte precursor was mixed with 1.0 g of Pt/C (Pt: 28 wt %, Tanaka) and 0.1 g of Cr₃C₂ and stirred for 15 minutes in a mortar to prepare a positive electrode slurry including a lithium ion conductive polymer electrolyte.

The positive electrode slurry was coated on a lithium-aluminum titanium phosphate (“LATP”) lithium ion conductive solid electrolyte membrane with a thickness of 250 μm (glass-ceramic, OHARA), dried at a temperature of 25° C. for 24 hours, and then heat-treated in a vacuum at 120° C. for 2 hours to prepare a positive electrode, in which a lithium ion conductive polymer electrolyte is impregnated.

Here, an amount of Cr₃C₂ used in the positive electrode slurry was about 5 parts by weight based on 100 parts by weight of the entire positive electrode, in which a lithium ion conductive polymer electrolyte is impregnated, and a weight ratio of Pt/C:polyethylene oxide+LiN(SO₂CF₃) was 1:1.

### Preparation Example 3

### Preparation of Positive Electrode, in which Lithium Ion Conductive Polymer Electrolyte is Impregnated

4.14 g of polyethylene oxide (PEO, a weight average molecular weight: 600,000 Daltons, Aldrich), and 1.5 g of LiN(SO₂CF₃)₂ (lithium bis(trifluoromethanesulfonyl)imide, “LiTFSI”) were mixed with a solvent, NMP, to prepare a lithium ion conductive polymer electrolyte precursor. 1.0 g of the lithium ion conductive polymer electrolyte precursor was mixed with 1.0 g of Pt/C (Pt: 28 wt %, Tanaka) and 0.1 g of ZrC and stirred for 15 minutes in a mortar to prepare a positive electrode slurry including a lithium ion conductive polymer electrolyte.

The positive electrode slurry was coated on a lithium-aluminum titanium phosphate (“LATP”) lithium ion conductive solid electrolyte membrane with a thickness of 250 μm (glass-ceramic, OHARA), dried at a temperature of 25° C. for 24 hours, and then heat-treated in a vacuum at 120° C. for 2 hours to prepare a positive electrode, in which a lithium ion conductive polymer electrolyte is impregnated.

Here, an amount of ZrC used in the positive electrode slurry was about 5 parts by weight based on 100 parts by weight of the entire positive electrode, in which a lithium ion conductive polymer electrolyte is impregnated, and a weight ratio of Pt/C:polyethylene oxide+LiN(SO₂CF₃) was 1:1.

### Comparative Preparation Example 1

### Preparation of Positive Electrode, in which Lithium Ion Conductive Polymer Electrolyte is Impregnated

4.14 g of polyethylene oxide (PEO, a weight average molecular weight: 600,000 Daltons, Aldrich), and 1.5 g of LiN(SO₂CF₃)₂ (lithium bis(trifluoromethanesulfonyl)imide, “LiTFSI”) were mixed with a solvent, NMP, to prepare a lithium ion conductive polymer electrolyte precursor. 1.0 g of the lithium ion conductive polymer electrolyte precursor was mixed with 1.0 g of Pt/C (Pt: 28 wt %, Tanaka) and stirred for 15 minutes in a mortar to prepare a positive electrode slurry including a lithium ion conductive polymer electrolyte.

The positive electrode slurry was coated on a lithium-aluminum titanium phosphate (“LATP”) lithium ion conductive solid electrolyte membrane with a thickness of 250 μm (glass-ceramic, OHARA), dried at a temperature of 25° C. for 24 hours, and then heat-treated in a vacuum at 120° C. for 2 hours to prepare a positive electrode, in which a lithium ion conductive polymer electrolyte is impregnated.

Here, a weight ratio of Pt/C:polyethylene oxide+LiN(SO₂CF₃) used in the positive electrode slurry was 1:1.

The positive electrodes, in which the lithium ion conductive polymer electrolyte is impregnated, prepared in Preparation Examples 1 to 3 and Comparative Example 1, exhibit results as shown in Table 1 below.

TABLE 1

| | | Amount of positive electrode additive based |
|---|---|---|
| | Type of | on 100 parts by weight of the entire positive |
| | positive | electrode, in which a lithium ion conductive |
| | electrode | polymer electrolyte is impregnated |
| | additive | (Parts by weight) |
| Example 1 | TiC | 5 |
| Example 2 | Cr₃C₂ | 5 |
| Example 3 | ZrC | 5 |
| Comparative | — | — |
| Example 1 | | |

### Manufacture of Lithium Air Battery

### Example 1

### Manufacture of Lithium Air Battery

A copper foil was fixed on a Teflon case, a lithium metal thin film negative electrode was installed thereon, and a lithium ion conductive polymer electrolyte membrane was disposed on the lithium metal thin film.

Here, 2.07 g of polyethylene oxide (PEO, 600,000 Daltons weight average molecular weight, available from Aldrich) and 0.75 of lithium bis(trifluoromethanesulfonyl)imide (“LiTFSI”) were mixed in acetonitrile, as a solvent, and then acetonitrile, the solvent, was slowly dried and removed to prepare a lithium ion conductive polymer electrolyte membrane.

The positive electrode, in which a lithium ion conductive polymer electrolyte is impregnated, and which was prepared in Preparation Example 1, was stacked on the lithium ion conductive polymer electrolyte membrane. A gas diffusion layer (Toray, H030-5% polytetrafluoroethylene (“PTFE”)) and a stainless steel wire (SUS) mesh were, each respectively, stacked on the positive electrode as a gas diffusion layer and a current collector to manufacture a lithium air battery.

In other words, a lithium air battery was manufactured as a stack of the copper foil—the lithium metal thin film negative electrode—the lithium ion conductive polymer electrolyte membrane—the lithium ion conductive solid electrolyte membrane—the positive electrode, in which a lithium ion conductive polymer electrolyte is impregnated, and which was prepared in Preparation Example 1—the gas diffusion layer—the SUS mesh, in the stated order.

Lastly, the stack was covered with a Teflon case, pressed with a pressing member, and thus the lithium air battery was fixed. An exemplary embodiment of a structure of the lithium air battery is shown in FIG. 2.

### Example 2

### Manufacture of Lithium Air Battery

A lithium air battery was manufactured in the same manner as in Example 1, except that the positive electrode, in which a lithium ion conductive polymer electrolyte is impregnated, and which was prepared in Preparation Example 2, was used instead of the positive electrode, in which a lithium ion conductive polymer electrolyte is impregnated, and which was prepared in Preparation Example 1.

### Example 3

### Manufacture of Lithium Air Battery

A lithium air battery was manufactured in the same manner as in Example 1, except that the positive electrode, in which a lithium ion conductive polymer electrolyte is impregnated, and which was prepared in Preparation Example 3, was used instead of the positive electrode, in which a lithium ion conductive polymer electrolyte is impregnated, and which was prepared in Preparation Example 1.

### Comparative Example 1

### Manufacture of Lithium Air Battery

A lithium air battery was manufactured in the same manner as in Example 1, except that the positive electrode, in which a lithium ion conductive polymer electrolyte is impregnated, and which was prepared in Comparative Preparation Example 1, was used instead of the positive electrode, in which a lithium ion conductive polymer electrolyte is impregnated, and which was prepared in Preparation Example 1.

### Evaluation of Battery Characteristics

### Evaluation Example 1

### Charging/Discharging Characteristics Evaluation

Charging/discharging characteristics of the lithium air batteries prepared in Examples 1 to 3 and Comparative Example 1 were evaluated.

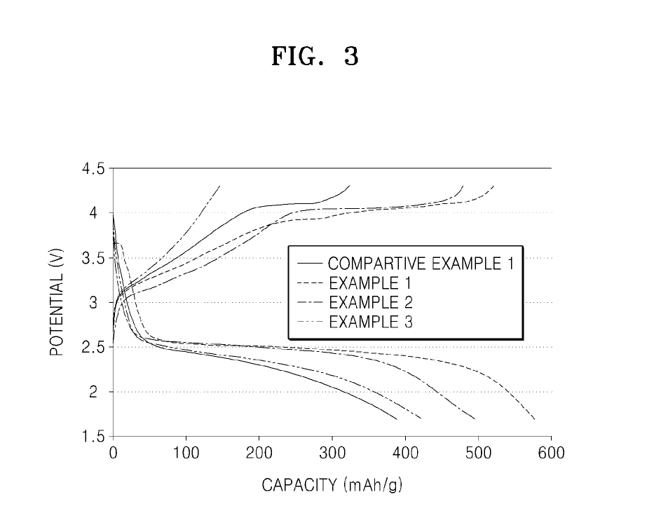

In order to evaluate the charging/discharging characteristics, the lithium air batteries prepared in Examples 1 to 3 and Comparative Example 1 were discharged with a constant current of 0.24 milliamperes per square centimeter (mA/cm²) at 60° C. and 1 atmosphere (atm) in an oxygen atmosphere up to 1.7 V, and then the same current was used to charge the batteries to 4.3 V to perform a charging/discharging characteristics evaluation after the first cycle of charging and discharging. Results are shown in Table 2 and FIG. 3.

Through the charging/discharging characteristics evaluation, a charge capacity, a discharge capacity, an average charging voltage, and an average discharging voltage were measured, and thus a charging/discharging efficiency and an energy efficiency were calculated by using Equation 1 and Equation 2. Here, a unit weight in the measured discharge capacity is a weight of Pt/C in the positive electrode.

Charging/discharging efficiency (%)=[(Charge capacity)/(Discharge capacity)×100%] Equation 1

Energy efficiency (%)=[E(discharge)/E(charge)×100%] Equation 2

In Equation 2, E(charge) is an average voltage during charging the battery, and E(discharge) is an average voltage during discharging the battery. E(charge) and E(discharge) are each calculated by integrating a charge curve and a discharge curve in an electric capacity (x-axis)-voltage (y-axis) graph and dividing the integrated values by the maximum discharge capacity and the maximum charge capacity, respectively.

TABLE 2

| | | | | Average | Average | |
|---|---|---|---|---|---|---|
| | Discharge | Charge | Charge/discharge | discharge | charge | Energy |
| | capacity | capacity | efficiency | voltage | voltage | efficiency |
| | mAh/g | mAh/g | % | V | V | % |
| Example 1 | 578 | 520 | 90 | 2.46 | 3.81 | 65 |
| Example 2 | 495 | 479 | 97 | 2.41 | 3.75 | 64 |
| Example 3 | 421 | 145 | 35 | 2.32 | 3.59 | 65 |
| Comparative | 388 | 323 | 83 | 2.30 | 3.79 | 61 |
| Example 1 | | | | | | |

Referring to Table 2 and FIG. 3, a discharge capacity of the lithium air batteries manufactured in Examples 1 to 3 improved compared to a discharge capacity of the lithium air battery manufactured in Comparative Example 1. The charge/discharge efficiency of the lithium air batteries manufactured in Examples 1 and 2 improved compared to a charge/discharge efficiency of the lithium air battery manufactured in Comparative Example 1.

Also, an average discharge voltage of the lithium air batteries manufactured in Examples 1 to 3 improved compared to an average discharge voltage of the lithium air battery manufactured in Comparative Example 1. An energy efficiency of the lithium air batteries manufactured in Examples 1 to 3 improved compared to an energy efficiency of the lithium air battery manufactured in Comparative Example 1.

As described above, according to the one or more of the above embodiments, a positive electrode for a lithium air battery includes a carbonaceous material and a carbide of a metal or a semi-metal element, and thus a discharge efficiency, a charging/discharging efficiency, and a discharge voltage of the lithium air battery may be improved.

It should be understood that the exemplary embodiments described herein should be considered in a descriptive sense only and not for purposes of limitation. Descriptions of features, advantages, or aspects within each embodiment shall be considered as available for other similar features, advantages, or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A lithium air battery comprising:
a negative electrode capable of incorporation and deincorporation of lithium ions;
a positive electrode capable of incorporating and deincorporating oxygen; and
a lithium ion conductive polymer electrolyte disposed between the negative electrode and the positive electrode,
wherein the positive electrode comprises a carbonaceous material and a carbide of a metal or a semi-metal element.

2. The lithium air battery of claim 1, wherein the lithium ion conductive polymer electrolyte comprises a lithium salt and a hydrophilic polymer.

3. The lithium air battery of claim 2, wherein the hydrophilic polymer comprises at least one selected from an alkylene oxide polymer, a hydrophilic acryl polymer, a hydrophilic methacryl polymer, a hydrophilic acrylonitrile polymer, a hydrophilic vinylidene fluoride polymer, a hydrophilic acrylonitrile polymer, a hydrophilic vinylidene fluoride polymer, a hydrophilic urethane polymer, and a hydrophilic cellulose polymer.

4. The lithium air battery of claim 2, wherein the lithium salt comprises at least one selected from LiPF₆, LiBF₄, LiSbF₆, LiAsF₆, LiN(SO₂CF₃)₂, LiN(SO₂C₂F₅)₂, LiN(SO₂F₂)₂, LiC₄F₉SO₃, LiClO₄, LiAlO₂, LiAlCl₄, LiN(CₓF₂ₓ₊₁SO₂)(C_{y}F_{2y+1}SO₂) wherein x and y are a natural number, LiF, LiBr, LiCl, LiI, and LiB(C₂O₄)₂.

5. The lithium air battery of claim 1, wherein a portion of the lithium ion conductive polymer electrolyte is disposed in the positive electrode.

6. The lithium air battery of claim 1, wherein the positive electrode comprises a composite of the carbonaceous material and the carbide of a metal or a semi-metal element.

7. The lithium air battery of claim 1, wherein the carbide of a metal or a semi-metal element is a carbide of at least one element selected from Si, Ti, Mn, Co, Ni, V, Ge, Nb, Zr, Mo, Fe, Al, Ag, Cr, Sn, Ta, and W.

8. The lithium air battery of claim 1, wherein an average particle diameter of the carbide of a metal or a semi-metal element is in a range of about 1 nanometer to about 10 micrometers.

9. The lithium air battery of claim 5, wherein an amount of the carbide of a metal or a semi-metal element is about 1 part to about 30 parts by weight, based on 100 parts by weight of an entirety of the positive electrode, in which a portion of the lithium ion conductive polymer electrolyte is disposed.

10. The lithium air battery of claim 1, wherein the carbonaceous material comprises a porous carbonaceous material.

11. The lithium air battery of claim 10, wherein an average particle diameter of primary particles of the porous carbonaceous material is in a range of about 10 nanometers to about 1 micrometer.

12. The lithium air battery of claim 1, wherein an average discharge voltage of the positive electrode is greater than 2.30 volts.

13. The lithium air battery of claim 1, wherein a discharge capacity per unit weight of the positive electrode is greater than 400 milliampere-hours per gram.

14. The lithium air battery of claim 1, wherein the positive electrode further comprises an oxygen oxidation/reduction catalyst.

15. The lithium air battery of claim 1, further comprising a lithium ion conductive solid electrolyte membrane, wherein the lithium ion conductive solid electrolyte membrane is disposed between the negative electrode and the lithium ion conductive polymer electrolyte.

16. The lithium air battery of claim 15, wherein the lithium ion conductive solid electrolyte membrane comprises at least one selected from a lithium ion conductive glass and a crystalline lithium ion conductive phase.

17. The lithium air battery of claim 1, wherein the negative electrode comprises at least one selected from lithium metal, an alloy comprising lithium metal, and a lithium intercalation compound.

18. A lithium air battery comprising:
a negative electrode capable of incorporation and deincorporation of lithium ions;
a positive electrode capable of incorporating and deincorporating oxygen, wherein the positive electrode comprises
a carbonaceous material and a carbide of a metal or a semi-metal element, and
a lithium ion conductive polymer electrolyte; and
a lithium ion conductive polymer electrolyte membrane between the negative electrode and the positive electrode.

19. A positive electrode for a lithium air battery comprising a carbonaceous material and a carbide of a metal or a semi-metal element.

20. The positive electrode of claim 19, wherein the positive electrode comprises a composite of a carbonaceous material and a carbide of a metal or a semi-metal element.
